(19) United States
(12) Patent Application Publication
(10) Pub. No.: US 2015/0248404 A1
(43) Pub. Date: Sep. 3, 2015

(54) DATABASE SCHEMA MIGRATION

(71) Applicant: Red Hat, Inc., Raleigh, NC (US)

(72) Inventors: Jan Pazdziora, Brno (CZ); Milan Zazrivec, Brno (CZ)

(73) Assignee: Red Hat, Inc., Raleigh, NC (US)

(21) Appl. No.: 14/266,399

(22) Filed: Apr. 30, 2014

Related U.S. Application Data
(63) Continuation-in-part of application No. 14/193,683, filed on Feb. 28, 2014.

(51) Int. Cl. G06F 17/30

(52) U.S. Cl. CPC G06F 17/303; G06F 17/30292; G06F 17/30339

(57) ABSTRACT

Various example embodiments are directed to systems and methods for migrating a database from a source database having a source schema to a target database having a target schema. For example, a computing device may identify a first source schema table associated with a first migration instruction. The first migration instruction may comprise a plurality of migration instruction sets. Each of the plurality of migration instruction sets may correspond to a version of the first source schema table. The computing device may determine that there is a match between the first source schema table and a first migration instruction set and may execute the first migration instruction set. Executing the first migration instruction set may comprise selecting at least one column of the first source schema table and writing the at least one column of the first source schema table to a first target schema table.

### RELATED APPLICATION

This application is a continuation-in-part of U.S. application Ser. No. 14/193,683 filed on Feb. 28, 2014, entitled DATABASE SCHEMA MIGRATION, which is incorporated herein by reference in its entirety.

### BACKGROUND

Databases play an increasingly important role in modern life and business. Businesses have come to use databases in any number of different contexts. Human resource departments use databases to store data describing employees, including, compensation information, address information, etc. Sales and marketing departments use customer relationship management (CRM) databases to store data describing customers including, for example, purchases, product preferences, etc. Information technology (IT) departments use databases for many purposes including, for example, storing data describing computer devices, software applications, etc. Consumers too are becoming increasingly dependent on databases. For example, a typical computer device user may use a media application that maintains a database of available media files, a calendar or e-mail application that maintains a database of personal and/or business contacts, a financial application that maintains a database of financial records, and others.

From time to time, it is desirable to migrate the data stored at a database to another database organized according to a different schema. For example, database migrations are often performed when upgrading to a different type or version of a database, when merging redundant databases or systems, etc. Database migration can be particularly challenging when the source and target databases are not organized according to the same schema and/or do not use the same database management system (DBMS). These migrations often require considerable time and effort from human programmers and can consume considerable computing resources.

### SUMMARY

Various example embodiments are directed to systems and methods for migrating a database from a source database having a source schema to a target database having a target schema. For example, a computing device may identify a first source schema table associated with a first migration instruction. The first migration instruction may comprise a plurality of migration instruction sets. Each of the plurality of migration instruction sets may correspond to a version of the first source schema table. The computing device may determine that there is a match between the first source schema table and a first migration instruction set and may execute the first migration instruction set. Executing the first migration instruction set may comprise selecting at least one column of the first source schema table and writing the at least one column of the first source schema table to a first target schema table.

In some examples, the computing device receives a list of tables at the source database comprising a first source schema table. The computing device traverses the list of tables determining, for each table, whether there is a corresponding migration instruction. For a first source schema table, the computing device may identify an associated first migration instruction that comprises a plurality of migration instruction sets. Each of the plurality of migration instruction sets may correspond to a version of the first source schema table identified by associated schema identifier data. The computing device may match the first source schema table to schema identifier data associated with a first migration instruction set selected from the plurality of migration instruction sets and execute the first migration instruction set. Executing the first migration instruction set may comprise selecting at least one column of the first source schema table and writing the at least one column of the first source schema table to a first target schema table.

### FIGURES

Various example embodiments are described herein in conjunction with the following figures, wherein:

FIG. 1 is a diagram showing one example of an environment for migrating database schemas.

FIG. 2 is a flow chart showing one example of a process flow for migrating data from the source database to the target database.

FIG. 3 is a flow chart showing one example of a process flow for executing the database migration.

FIG. 4 is a flow chart showing one example of a process flow for executing the database migration while supporting multiple source schemas.

FIG. 5 is a process flow showing one example of a process flow for migrating a database utilizing a pre-migration phase.

### DESCRIPTION

Various example embodiments are directed to systems and methods for migrating data from a source database organized according to a source schema to a target database organized according to a target schema. For example, a computer system may utilize data manipulation language commands to retrieve objects from the source schema and place the objects at desired positions in the target schema. For example, the computer system may select a column from one or more tables of a source database organized according to the source schema. Data returned by the database select or other command may be written to an appropriate column at an appropriate table of the target database according to the target schema. The set of commands that are executed may define a mapping between the source schema and the target schema such that the data and data relationships of the source database are maintained after migration to the target database. In various examples, the data manipulation language command or commands utilized for the migration are common to two or more database management systems (DBMSs). In this way, the systems and methods described herein may be capable of migrating directly between source and target databases with different DBMSs.

In various example embodiments, tables at the source schema may be associated with corresponding migration instructions. For example, source schema tables that do not have a one-to-one relationship with a corresponding target schema table may be associated with migration instructions. The migration instructions may include a set of data manipulation language commands that are executed by the computer system to retrieve objects from the source schema table and write the objects to the proper tables and/or columns at one or more target schema tables. Source schema tables that do not require transformation (e.g., tables that do have a one-to-one correlation with a corresponding target schema table) may not have associated migration instructions. When the computer device encounters a source schema table without migration instructions, it may transfer the table to the target database without transformation.

In various example embodiments, the computer system is configured to support more than one source schema. For example, migration instructions associated with a table may include multiple migration instruction sets as well as schema identifier data. During migration, the computer system utilizes the schema identifier data to determine the source schema of a table. The computer system then selects a migration instruction set corresponding to the determined source schema and applies the selected migration instruction set to transfer the table to the target schema. In this way, the migration may support databases that have been partially upgraded. For example, in some circumstances, a database administrator upgrades some, but not all, of the tables in the database to an upgraded schema. In these cases, determining the source schema on a table-by-table basis may simplify the migration process. This, however, is optional and some examples may not support more than one source schema and/or may determine the source schema for the entire source schema database, e.g., not on a table-by-table basis.

Reference will now be made in detail to several example embodiments, which are illustrated in the accompanying figures. Wherever practical, similar or like reference numbers may be used in the figures and may indicate similar or like functionality. The figures depict examples of the disclosed systems (or methods) for purposes of illustration only. One skilled in the art will readily recognize from the following description that alternative examples of the structures and methods illustrated herein may be employed without departing from the principles described herein.

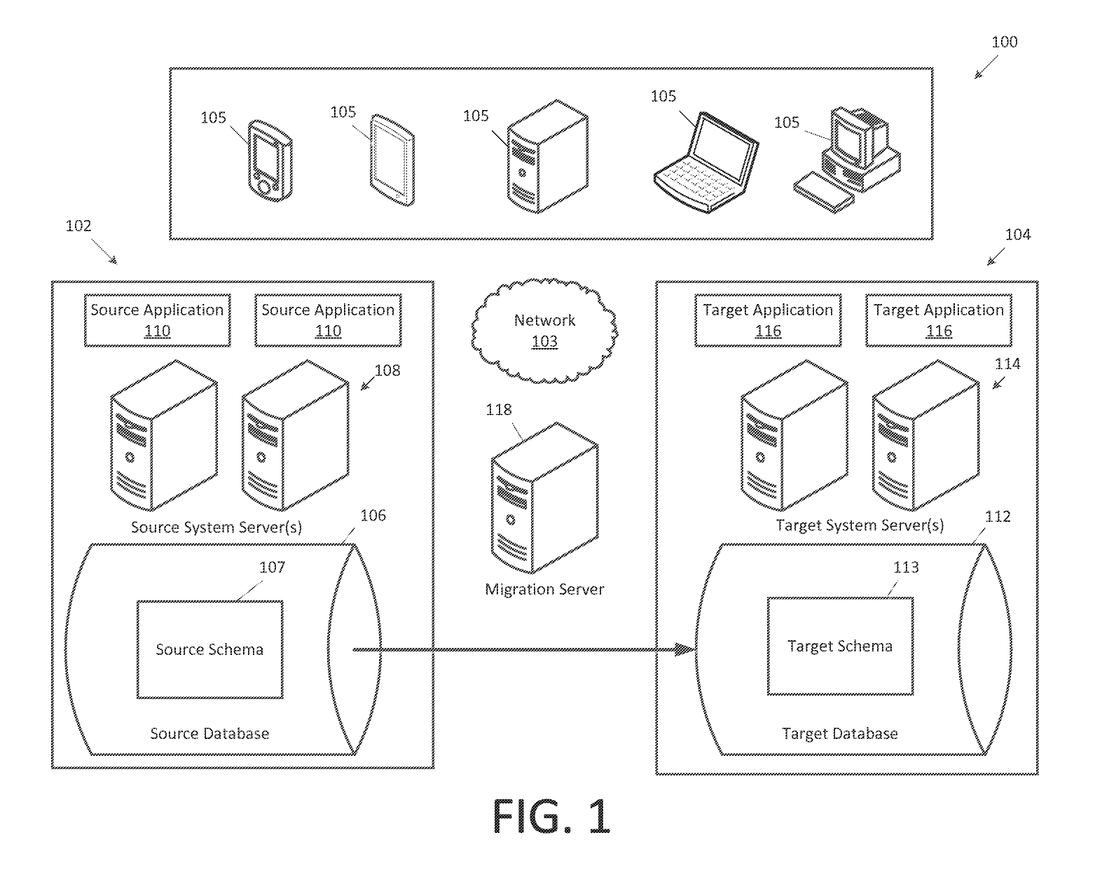

FIG. 1 is a diagram showing one example of an example environment 100 for migrating database schemas. The environment 100 comprises a source database 106 organized according to a source schema 107 and a target database 112 organized according to a target schema 113. The databases 106, 112 may be any suitable type of database organized according to any suitable schemas 107, 113. In some examples, the databases 106, 112 are relational databases organized according to a relational schema. The source and target schemas 107, 113 may define a series of tables, as well as other schema objects such as indices, links, triggers, various commands, etc. The schema objects describe the way that data is stored according to the schema. Because the schemas 107, 113 are different, however, not all of the schema objects of the source schema 107 are translatable to the target schema 113. For example, there may not be a one-to-one correlation between every table (or other object) in the source schema 107 and a corresponding table in the target schema 113.

The databases 106, 112 may be associated with respective database management systems (DBMSs). The source database 106 and the target database 112 may utilize the same DBMS or different DBMSs. A DBMS is a software application that facilitates interaction between the respective databases 106, 112 and other components of the environment 100. For example, a DBMS may have an associated data definition and/or manipulation language describing commands that may be executed to interact with the database. Examples of suitable DBMSs include MySQL, MariaDB, PostgreSQL, SQLite, Microsoft SQL Server available from the MICROSOFT CORPORATION, various DBMSs available from ORACLE CORPORATION, various DBMSs available from SAP AG, IBM DB2, available from THE INTERNATIONAL BUSINESS MACHINES CORPORATION, etc.

The databases 106, 112 are shown in the context of the example environment 100, which illustrates one potential configuration in which a database migration may occur. In addition to the databases 106, 112, the environment 100 comprises a source system 102, a target system 104, user devices 105, and a migration server 118. The source system 102 comprises components associated with the source database 106 including, for example, one or more source servers 108 for administering the source database 106. For example, source servers 108 may execute the DBMS for the source database 106. The source system 102 may also be associated with one or more source applications 110. Source applications 110 are configured to interact with the source database 106. For example, source applications 110 may be configured to read and/or write to the source database 106 in a manner that is consistent with the source schema 107. The source applications 110 may be executed by any suitable system or device. For example, source applications 110 may be executed by the source servers 108, a user device 105, etc. The target system 104 comprises components associated with the target database 112 including, for example, one or more target servers 114 for administering the target database 112. The target servers 114, for example, may execute a DBMS for the target database 112. Target applications 116 are configured to interact with the target database 112. For example, the target applications 116 may be configured to interact with data stored according to the target schema 113.

The user devices 105 may include any suitable devices that interact with the databases 106, 112. Examples of user devices 105 may include desktop computers, laptop computers, servers, tablet computers, cellular or other mobile phones, or any suitable device capable of interacting with the systems 102, 104. In some examples, the environment 100 also comprises a migration server 118. The migration server 118 may perform various tasks related to database migration from the source database 106 to the target database 112. The various components of the environment 100 may be in communication with one another via a network 103. The network 103 may be any suitable type of wired, wireless, or mixed network and may comprise, for example, the Internet, a local area network (LAN), a wide area network (WAN), etc.

FIG. 1 illustrates but one example environment describing one example way that the databases 106, 112 may be arranged for a database migration. For example, although FIG. 1 shows the source database 106 and target database 112 as components of separate systems 102, 104, the schema migration systems and methods described herein may be executed to migrate data between databases having any suitable hardware relationship to one another. In some examples, both the source database 106 and the target database 112 may be part of a common system with DBMS s for both databases 106, 112 executed by a common server or set of servers. In some examples, the source database 106 and target database 112 may be stored, in whole or in part, on common physical storage devices.

During database migration, data stored at the source database 106 according to the source schema 107 is transferred to the target database 112. Often, migration involves modifications to the data structure to comply with the target schema 113. Migration, as described herein, involves actions that may be executed on the source database 106 as well as on the target database 112. These actions are described herein as being executed by the migration server 118. Any of the actions described herein, however, may be executed by any system having access to the respective databases 106, 112. For example, various aspects of the described database migration may be performed by the source server(s) 108 and/or the target server(s) 114.

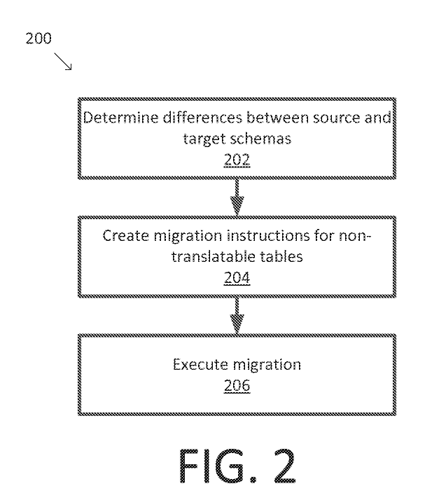

FIG. 2 is a flow chart showing one example of a process flow 200 for migrating data from the source database 106 to the target database 112. Although the process 200 is described with reference to the flowchart illustrated in FIG. 2, many other methods of performing the acts associated with the process 200 may be used. For example, the order of some of the acts may be changed, certain actions may be combined with other actions, and some of the actions described are optional. At 202, the migration server 118 may determine differences between the source and target schemas. This may involve determining tables from the source schema 107 that are not translatable to the target schema 113. For example, a portion of the tables of the source schema 107 may have a one-to-one correlation to corresponding tables of the target schema 113. These translatable tables may later be copied from the source database 106 to the target database 112 without further modification. Non-translatable source schema tables that lack a one-to-one corresponding table in the target schema 113, however, may require additional processing, as described herein. In examples supporting multiple source schemas, the migration server 118 may determine differences between each of the supported source schemas and the target schema 113. Also, for example, when multiple source schemas are supported, a table may be considered non-translatable if a translation is required from at least one of the source schemas.

At 204, migration instructions may be created for each non-translatable source schema table. The migration instructions may be generated in an automated manner (e.g., by the migration server 118 or other suitable processing component). In some examples, the migration instructions may be generated manually, for example, by a developer after reviewing the non-translatable tables generated at 202. The migration instructions for a given source schema table may define a mapping between columns of the source schema table and columns of one or more tables of the target schema 113. In some examples, migration instructions for each source schema table are stored at a file that may have a name matching the name of the corresponding database table. The file may be referred to as a definition file. Each definition file may comprise the migration instructions for the corresponding table, which may be expressed as a database query or definition of another operation that is to be performed in the source database to provide transformed data for migrating. In some examples, migration instructions for more than one table may be included in a common definition file.

In various example embodiments, migration instructions are defined utilizing data manipulation language commands that are either common to the DBMSs of both the source database 106 and target database 112, or return data in a known format recognizable according to the DBMS of the target database 112. In some examples, migration instructions may use database selects or similar commands. A database select returns requested data from a database such as for example, a column or columns of a source schema table. During migration, the returned data is written to the appropriate column or columns of one or more corresponding target schema tables. The migration instructions may specify database selects to be executed on the source database 106, and corresponding tables and columns at the target database 112 for receiving the returned data. In some examples, the source schema 107 may define tables with data that is not included in the target schema 113. Migration instructions for tables of this type may indicate that the tables should be skipped and not moved to the target database 112. Upon completion, migration instructions may be stored, for example, in a table definition file that is associated with the appropriate table.

In examples supporting multiple source schemas, the migration instructions for a source schema table may include multiple migration instruction sets, with each set corresponding to one supported source schema. The migration instructions may also include schema identifier data that may be used by the migration server 118 during execution of the migration to identify the source schema of the table.

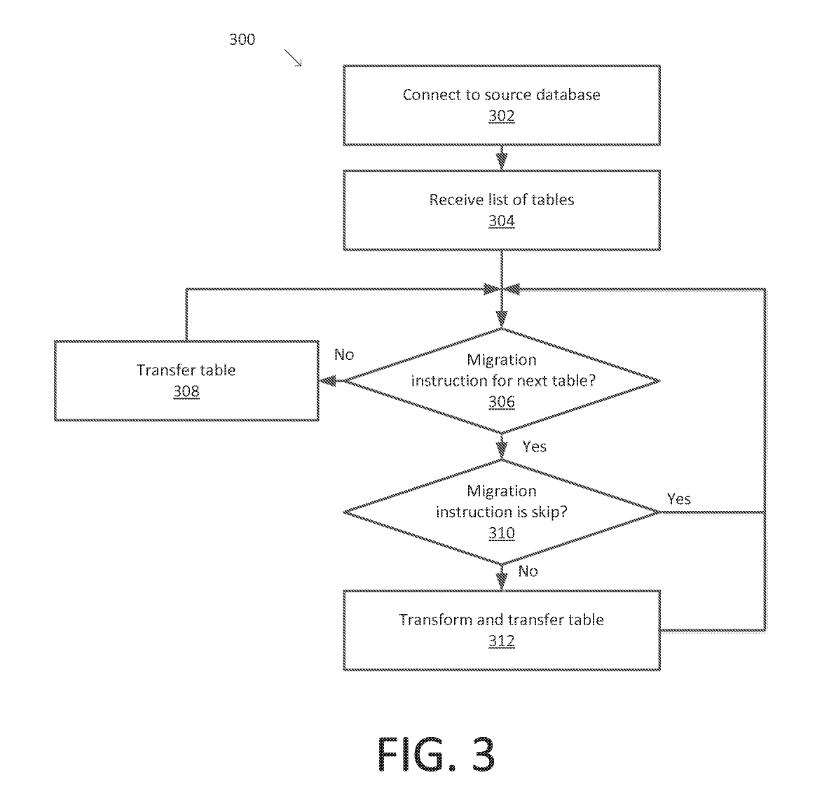

At 206, the migration server 118 may execute the migration. Executing the migration may involve, for example, examining all of the tables of the source database 106 (e.g., source schema tables). FIG. 3 is a flow chart showing one example of a process flow 300 for executing the database migration, at 206. The process flow 300 illustrates one example way to execute the database migration described at 206 above. Although the process flow 300 is described with reference to the flowchart illustrated in FIG. 3, many other methods of performing the acts associated with the process flow 300 may be used. For example, the order of some of the acts may be changed, certain actions may be combined with other actions, and some of the actions described are optional.

At 302, the migration server 118 may connect to the source database 106. At 304, the migration server 118 may receive a list of tables at the source database 106. For example, the list of tables may be received from a source server 108 and/or through a source application 110. To perform the migration, the migration server 118 may traverse the list of tables. Traversing the list of tables may comprise considering all or a portion of the list of tables, for example, successively. In one example, traversing the list of tables comprises considering a first table on the list, for example, as described herein below with respect to actions 306, 308, 310 and 312. When consideration of the first table is complete, migration server 118 may consider a next table from the list of tables until the processing is complete (e.g., until all tables on the list have been considered).

The migration server 118 may determine, at 306, whether there is a migration instruction for the next table (e.g., the next table to be considered). If there is no migration instruction for the next table, the migration server 118 may, at 308, transfer the considered table at to the target database 112, for example, without changes, and then proceed to evaluate at 306 for a next considered table. In some examples, determining whether there is a migration instruction for a particular table may involve determining whether there exists a definition file for the table. The definition file for the table may be stored, for example, at the source database 106, at storage associated with one of the source servers 108, and/or at data storage associated with the migration server 118. If there is a migration instruction for the considered table at 306, the migration server 118 may determine, at 310, whether the migration instruction indicates that the considered table is to be skipped. For example, a table may be skipped if it occurs in the source schema 107, but not in the target schema 113. If the considered table is skipped, the migration server 118 may proceed to the next table at 306. If the considered table is not skipped, the migration server 118 may, at 312, transform the considered table and transfer it to the target database 112. For example, the migration server 118 may utilize one or more database selects or similar data manipulation language commands to move data from the considered table to one or more columns of one or more corresponding target schema tables at the target database 112.

The process flow 300 may continue until all of the tables of the source schema 107 are traversed. In some examples, however, the migration server 118 may also traverse migration instructions that do not correspond to tables in the source schema 107. For example, the migration server 118 may traverse migration instructions that correspond to tables at the target schema 113 that do not have equivalents in the source schema 107. These migration instructions may have instructions to be executed by the migration server 118 to populate the target schema tables at the target database 112. For example, even if a target schema table has no analog in the source schema 107, it may include data from one or more source schema tables. Accordingly, the migration instructions for a target schema table may include instructions for selecting data from one or more source schema tables and migrating the data to the target database 112.

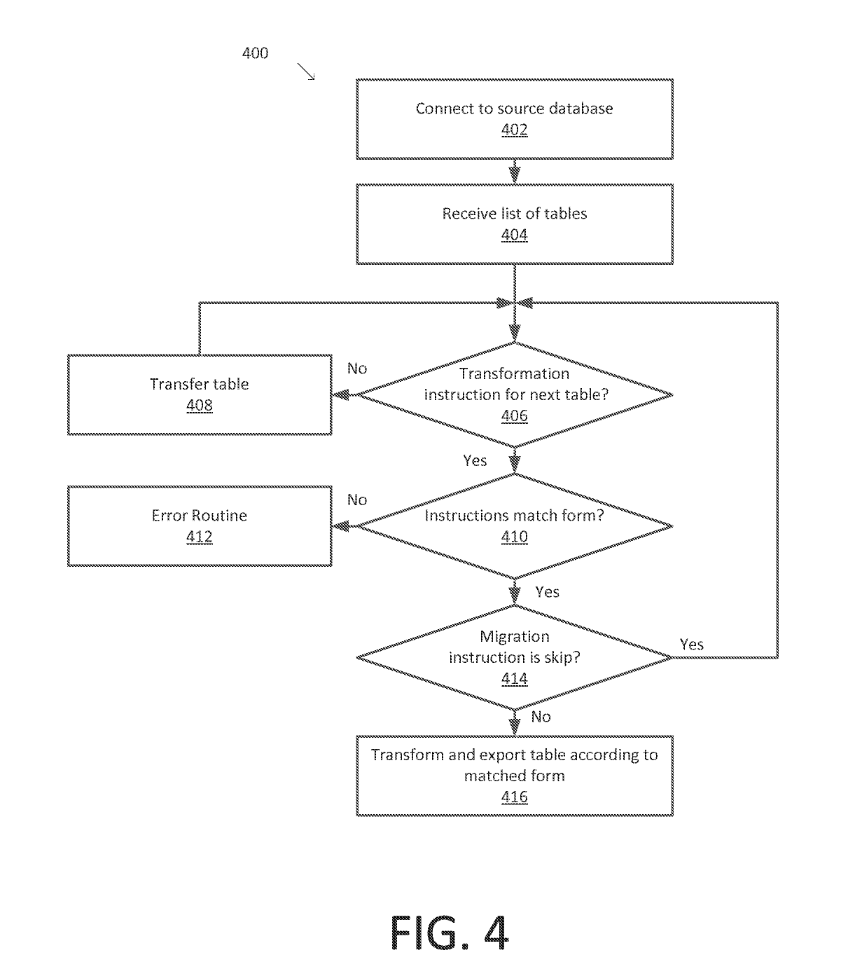

FIG. 4 is a flow chart showing one example of a process flow 400 for executing the database migration while supporting multiple source schemas. The process flow 400 illustrates another example way to execute the database migration described at 206 above. Although the process flow 400 is described with reference to the flowchart illustrated in FIG. 4, many other methods of performing the acts associated with the process flow 400 may be used. For example, the order of some of the acts may be changed, certain actions may be combined with other actions, and some of the actions described are optional.

At 402 and 404, the migration server 118 may connect to the source database 106 and receive the list of tables, for example, similar to 302 and 304 herein. Also similar to the process flow 300, the migration server 118 may traverse the tables of the source database 106. If there is no transformation instruction for the next table at 406, the migration server 118 may transfer the considered table to the target database 112 at 408. If there is a transformation instruction for the considered table, then the migration server may determine, at 410, whether there is a match between the considered table and a set of migration instructions. For example, the migration instructions may comprise schema identifier data associated with various migration instruction sets. The migration server 118 may match the schema identifier data to the considered table, and then select the migration instruction set associated with the considered table and the identified schema.

If a migration instruction set match is found at 410, the migration server 118 may determine, at 414, whether the migration instruction set is a skip. If so, then the migration server 118 may move to the next table. If not, the migration server 118 may apply the migration instruction set at 416 to migrate the considered table to the target database 112. If there is no instruction set match at 410, the migration server may execute an error routine 412. For example, there may not be an instruction set match if the considered data does not match any of the schema identifier data included in the migration instructions. The error routine 412 may treat the considered table in any suitable manner. For example, in some embodiments, migration server 118 may take no further action with the considered table and move to the next table at 406. Also, in some embodiments, the migration server 118 may transfer the considered table to the target database 112 without transformation.

As described above with respect to the process flow 300, the migration server 118 may also traverse migration instructions associated with tables that appear in the target schema 113 but not in the source schema 107 (e.g., target schema table migration instructions). The migration server 118 may identify database operations to populate the target schema tables with data from one or more source schema tables. In various embodiments, the target schema table migration instructions may also be version-specific. For example, target schema table migration instructions may include schema identifier data and corresponding instruction sets for different versions of different source schema tables from which the target schema table is populated. When the target schema table is populated from more than one source schema table, the migration instructions may comprise schema identification data and instruction sets for each supported permutation of source schema tables. For example, if the source schema 107 comprises two tables ti and tii, and each table can have two versions, then the schema table migration instructions may include schema identifier data for four combinations: (a) ti, version 1, tii, version 1; (b) ti, version 1, tii, version 2; (c) ti, version 2, tii, version 1; and (d) ti, version 2, tii, version 2. In some embodiments, target schema table instructions may support less than all possible permutations of source schema table versions.

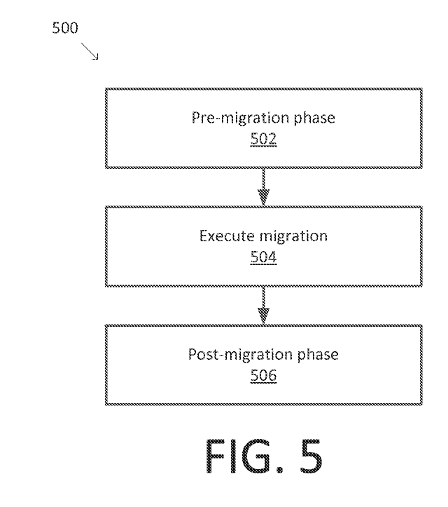

In various example embodiments, the migration server 118 may execute a pre-migration phase prior to executing the migration instructions. FIG. 5 is a process flow showing one example of a process flow 500 for migrating a database utilizing a pre-migration phase. Although the process flow 500 is described with reference to the flowchart illustrated in FIG. 5, many other methods of performing the acts associated with the process flow 500 may be used. For example, the order of some of the acts may be changed, certain actions may be combined with other actions, and some of the actions described are optional.

At 502, the migration server 118 may execute a pre-migration phase 502. In some examples, the pre-migration phase may be executed in whole or in part by the source servers 108. During the pre-migration phase, the migration server 118 may make one or more pre-migration modifications to the source database 106. Pre-migration modifications may include, for example, generating one or more pre-migration objects and/or executing one or more pre-migration commands at the source database 106. The pre-migration objects and/or commands may facilitate migration. For example, because the source database 106 and target database 112 are organized according to different schemas 107, 113, not all of the commands of the data manipulation language and database management system (DBMS) for the source database 106 may be operable for the target database 112. For example, command returns from the DBMS for the source database 106 may not be readable to the target database 112. For this reason, migration instructions may be focused on commands, such as the database select, that return data in a predictable format that is readable according to the target schema 113. This limits the flexibility to optimize the migration based on the properties of the data and/or schemas 107, 113. A pre-migration phase can address this difficulty by conditioning the data prior to migration, for example, using commands that are not available during migration. In some examples, the pre-migration phase may also support multiple source schema versions. For example, the migration server 118 may be programmed to generate different pre-migration objects based on a detected version of the source schema 107 and/or individual tables of the source schema 107.

At 504, the migration server 118 may execute the migration to the target database 112. Migration may be executed, for example, as described herein with respect to FIGS. 2-4. Instead of relying solely on the source schema tables, however, the migration instructions may also utilize pre-migration objects and/or source schema tables that have been modified by pre-migration commands. For example, a database select may be used to transfer data from a pre-migration table to a corresponding table at the target database 112. Also, for example, a database select may be utilized to transfer data from a source schema table utilizing a pre-migration index generated to streamline the select operation. Additionally, for example, a database select may be utilized to transfer data from one or more columns of a source schema table that was added during the pre-migration phase. Optionally, after migration, the migration server 118 or source servers 108 may execute a post-migration phase at 506. In the post-migration phase, pre-migration modifications to the source database 106 may be reversed, for example, returning the source database 106 to its pre-migration state according to the source schema 107. For example, if pre-migration database objects were generated, these may be deleted or moved from the source database 106. Also, for example, if pre-migration commands were executed, those commands may be reversed. In this way, the source database 106 may be returned to its original state under the source schema 107. This may allow source applications 110 to utilize the source database 106 after the migration is complete. Also, for example, returning the source database 106 to its pre-migration state may allow a migration operation to be performed multiple times. In this way, the enterprise executing the migration may execute test migrations without affecting the integrity of the source database 106. Additional examples of systems and methods for migrating databases utilizing pre-migration phases are provided in U.S. application Ser. No. 14/193,683 filed on Feb. 28, 2014, entitled DATABASE SCHEMA MIGRATION, which is incorporated herein by reference in its entirety.

Various example cases of the systems and methods described herein are provided. In a first example case, a table “t_old” exists in the source schema 107. An example format for t_old is provided below:

t_old

| | |
|---|---|
| col_1 | number |
| col_2 | string |
| col_3 | number |

The table told, in this example, is dropped in the target schema 113. In this case, the table t_old may have associated migration instructions that contain a ‘skip’ instruction. For example, there may be a definition file associated with the table t_old that contains the skip instruction. Referring to the process flow 300, the migration server 118 may determine that there is a migration instruction for the table t_old at 306. At 310, the migration server 118 may determine that the migration instruction is a skip instruction and may, thereafter, proceed to the next table without migrating table t_old to the target database 112.

In another example case, a table “t_new” exists in the target schema 113, but not at the source schema 107. The table t_new may be defined as follows:

t_new

| | |
|---|---|
| col_1 | number |
| col_2 | string |
| col_3 | number |

The columns col_{—}1, col_{—}2, and col_{—}3 may be from the table t_old described above. In such a scenario, the migration instructions for the table told may include a skip instruction, as described above. Also, as described above, the migration server 118 may consider a set of target schema table migration instructions associated with “t_new.” Example migration instructions are provided below:

missing table

select col_1, col_2, col_3 from t_old

The first line contains instruction “missing table.” This instruction may tell the migration tool that the considered table, t_new, does not exist in the source schema 107, but will exist in the target schema 113. The next line, which in some syntaxes may be indented with whitespace, contains an SQL query (e.g., a select instruction), which will be used to select the data and insert it into t_new.

In another example case, a table “t01” exists in both the source schema 107 and the target schema 113. In the source schema 107, the t01 comprises columns col01, col02, and col03, as indicated:

t01 -- source schema

| | |
|---|---|
| col01 | number |
| col02 | string |
| col03 | number |

In the target schema 113, column col03 is dropped:

t01 -- target schema

| | |
|---|---|
| col01 | number |
| col02 | string |

An example set of migration instructions for the table t01 is provided below:

col01, col02, col03

select col01, col02 from t01

The first line contains column names of table t01 in the old schema version. This may serve as the schema identifying data. For example, when the migration server 118 encounters a table t01 containing the listed columns, it may perform the associated migration instructions. In the syntax of the instant example, the associated migration instructions are listed below the schema identifier, indented on the next line. To execute the migration instructions, the migration server 118 may select columns col01 and col02, but not column col03, because this column does not exist in t01 in the target schema 113.

In yet another example case, the table t01 may change several times in several different versions of the source schema 107, for example, as indicated:

t01 -- source schema v1

| | |
|---|---|
| col01 | number |
| col02 | string |
| col03 | number |
| col04 | number |

t01 -- source schema v2

| | |
|---|---|
| col01 | number |
| col02 | string |
| col03 | number |

t01 -- target schema

| | |
|---|---|
| col01 | number |
| col02 | string |

In this example, in a first version of the source schema 107, the table t01 contains columns col01, col02, col03, and col04. In a second version of the source schema 107, the same table t01 contains columns col01, col02, and col03. In the target schema 113, the table t01 contains columns col01 and col02. Example migration instructions for t01, then, may include the following:

col01, col02, col03, col04

select col01, col02 from t01

col01, col02, col03

select col01, col02 from t01

Schema identifier data identifying the first version of the source schema 107 may indicate the columns of the table t01 according to the first version of the source schema 107, here col01 through col04. In the syntax of this example, the migration instructions associated with the schema identifier data are listed below the schema identifier, indented on the next line. For example, because t01, according to the target schema 113, comprises col01 and col02, the migration instructions may comprise a select instruction to move col01 and col02 from t01 to t01 at the target database 112. Second schema identifier data indicates the columns of the table t01 according to the second version of the source schema 107, here col01 through col03. Associated migration instructions are on the next line and indented. In this example, the migration instructions associated with the second schema identifier data are the same as those associated with the first schema identifier data, although this is not always the case. According to the syntax of this example, a blank line separates the two sets of migration instructions and schema identifiers.

In another example case, the table t01 at the first and second versions of the source schema 107 may be as described above. In addition another table t02 may be part of the source schema 107 and may include an additional column, cnew:

t02

| | |
|---|---|
| cnew | number |

In the target schema 113, the column cnew may be merged from table t02 to the table t01.

Example migration instructions for table t01 are provided below:

col01, col02, col03, col04

select t01.col01, t01.col02, t02.cnew from t01, t02 where

<JOINING CONDITIONS>

col01, col02, col03

select t01.col01, t01.col02, t02.cnew from t01, t02 where

<JOINING CONDITIONS>

Here, for both the first and second versions of the source schema 107, the migration instructions are the same. The column cnew is selected from source schema table t02 along with col01 and col02 from t01. The migration instruction may also include joining conditions describing how the columns col01, col02, and cnew are to be joined at the target schema table t01.

In yet another example case, the following tables may exist in the source schema 107:

ta1 -- source schema v1

| | |
|---|---|
| colA1 | number |
| colA2 | string |
| colA3 | string |
| colA4 | number |

ta1 -- source schema v2

| | |
|---|---|
| colA1 | number |
| colA2 | string |
| colA3 | string |

ta2 -- source schema v2

| | |
|---|---|
| colA4 | number |

In the target schema 113, the table ta1 may exist as indicated below. For example, the table ta2 may not be in the target schema 113.

ta1 -- target schema

| | |
|---|---|
| colA1 | number |
| colA2 | string |
| colA3 | string |
| colA4 | number |

Example migration instructions for table ta1 are provided below:

colA1, colA2, colA3, colA4

select ta1.colA1, ta1.colA2, ta1.colA3, ta1.colA4 from ta1 colA1,
colA2, colA3
select ta1.colA1, ta1.colA2, ta1.colA3, ta2.colA4 from ta1, ta2
where

<JOINING CONDITIONS>

As indicated, when the schema identifier indicates that the considered source schema table ta1 is configured according to the first version of the source schema 107, the migration server 118 may select all of the columns colA1, colA2, colA3, colA4 from ta1. When the schema identifier indicates that the considered source schema table ta1 is configured according to the second version of the source schema 107, the migration server 118 may select columns colA1, colA2, and colA3 from ta1 and colA4 from ta2.

Reference in the specification to, “embodiments,” “various example embodiments,” etc. means that a particular feature, structure, or characteristic described in connection with the example embodiments is included in at least one embodiment of the invention. The appearances of the above-referenced phrases in various places in the specification are not necessarily all referring to the same embodiment. Reference to embodiments is intended to disclose examples, rather than limit the claimed invention. While the invention has been particularly shown and described with reference to several embodiments, it will be understood by persons skilled in the relevant art that various changes in form and details can be made therein without departing from the spirit and scope of the invention.

It should be noted that the language used in the specification has been principally selected for readability and instructional purposes, and may not have been selected to delineate or circumscribe the inventive subject matter. Accordingly, the present disclosure is intended to be illustrative, but not limiting, of the scope of the invention.

It is to be understood that the figures and descriptions of example embodiments of the present disclosure have been simplified to illustrate elements that are relevant for a clear understanding of the present disclosure, while eliminating, for purposes of clarity, other elements, such as for example, details of system architecture. Those of ordinary skill in the art will recognize that these and other elements may be desirable for practice of various aspects of the present examples. However, because such elements are well known in the art, and because they do not facilitate a better understanding of the present disclosure, a discussion of such elements is not provided herein.

It is to be understood that the figures and descriptions of example embodiments of the present disclosure have been simplified to illustrate elements that are relevant for a clear understanding of the present disclosure, while eliminating, for purposes of clarity, other elements, such as for example, details of system architecture. Those of ordinary skill in the art will recognize that these and other elements may be desirable for practice of various aspects of the present examples. However, because such elements are well known in the art, and because they do not facilitate a better understanding of the present disclosure, a discussion of such elements is not provided herein.

In some examples of the present methods and systems disclosed herein, a single component can be replaced by multiple components, and multiple components replaced by a single component, to perform a given command or commands. Except where such substitution would not be operative to practice the present methods and systems, such substitution is within the scope of the present disclosure. Examples presented herein, including operational examples, are intended to illustrate potential implementations of the present method and system examples. Such examples are intended primarily for purposes of illustration. No particular aspect or aspects of the example method, product, computer-readable media, and/or system examples described herein are intended to limit the scope of the present disclosure.

The various components of the environment 100 may be and/or are executed by any suitable type of computing device including, for example, desktop computers, laptop computers, mobile phones, palmtop computers, personal data assistants (PDAs), etc. As used herein, a “computer,” “computer system,” “computer device,” or “computing device,” may be, for example and without limitation, either alone or in combination, a personal computer (PC), server-based computer, main frame, server, microcomputer, minicomputer, laptop, personal data assistant (PDA), cellular phone, pager, processor, including wireless and/or wireline varieties thereof, and/or any other computerized device capable of configuration for processing data for standalone application and/or over a networked medium or media. Computers and computer systems disclosed herein may include operatively associated memory for storing certain software applications used in obtaining, processing, storing, and/or communicating data. Such memory can be internal, external, remote, or local with respect to its operatively associated computer or computer system. Memory may also include any means for storing software or other instructions including, for example and without limitation, a hard disk, an optical disk, floppy disk, ROM (read-only memory), RAM (random-access memory), PROM (programmable ROM), EEPROM (extended erasable PROM), and/or other like computer-readable media.

Some portions of the above disclosure are presented in terms of methods and symbolic representations of operations on data bits within a computer memory. These descriptions and representations are the means used by those skilled in the art to most effectively convey the substance of their work to others skilled in the art. A method is here, and generally, conceived to be a sequence of actions (instructions) leading to a desired result. The actions are those requiring physical manipulations of physical quantities. Usually, though not necessarily, these quantities take the form of electrical, magnetic, or optical signals capable of being stored, transferred, combined, compared, and otherwise manipulated. It is convenient at times, principally for reasons of common usage, to refer to these signals as bits, values, elements, symbols, characters, terms, numbers, or the like. Furthermore, it is also convenient at times, to refer to certain arrangements of actions requiring physical manipulations of physical quantities as modules or code devices, without loss of generality. It should be borne in mind, however, that all of these and similar terms are to be associated with the appropriate physical quantities and are merely convenient labels applied to these quantities. Unless specifically stated otherwise as apparent from the preceding discussion, throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission, or display devices.

Certain aspects of the present disclosure include process steps and instructions described herein in the form of a method. It should be noted that the process steps and instructions of the present disclosure can be embodied in software, firmware, or hardware, and when embodied in software, can be downloaded to reside on and be operated from different platforms used by a variety of operating systems.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but is not limited to, any type of disk including floppy disks, optical disks, CD-ROMs, magnetic-optical disks, read-only memories (ROMs), random-access memories (RAMs), electrically-programmable read-only memories (EPROMs), electrically erasable programmable read-only memories (EEPROMs), magnetic or optical cards, application-specific integrated circuits (ASICs), or any type of media suitable for storing electronic instructions, and each coupled to a computer system bus. Furthermore, the computers and computer systems referred to in the specification may include a single processor or may be architectures employing multiple processor designs for increased computing capability.

The methods and systems presented herein, unless indicated otherwise, are not inherently related to any particular computer or other apparatus. Various general-purpose systems may also be used with programs in accordance with the teachings herein, or it may prove convenient to construct more specialized apparatus to perform the disclosed method actions. The structure for a variety of these systems will appear from the above description. In addition, although some of the examples herein are presented in the context of a particular programming language, the present disclosure is not limited to any particular programming language. A variety of programming languages may be used to implement the teachings of the present disclosure as described herein, and any references above to specific languages are provided for disclosure of enablement and best mode of the present disclosure.

The term “computer-readable medium” as used herein may include, for example, magnetic and optical memory devices such as diskettes, compact discs of both read-only and writeable varieties, optical disk drives, and hard disk drives. A computer-readable medium may also include non-transitory memory storage that can be physical or virtual.

We claim:

1. A computer-implemented system for migrating a database from a source database having a source schema to a target database having a target schema, wherein the source schema defines a plurality of source schema tables, the system comprising:
at least one processor and operatively associated memory, wherein the at least one processor is programmed to:
receive a list of tables at the source database, wherein the list of tables comprises a first source schema table;
traverse the list of tables, wherein the traversing comprises, for each table in the list of tables, determining whether there is a corresponding migration instruction;
for the first source schema table, identify an associated first migration instruction, wherein the first migration instruction comprises a plurality of migration instruction sets, wherein each migration instruction set of the plurality of migration instruction sets corresponds to a version of the first source schema table, and wherein each migration instruction set of the plurality of instruction sets is associated with schema identifier data identifying the version of the source schema table corresponding to the migration instruction set;
match the first source schema table to schema identifier data associated with a first migration instruction set selected from the plurality of migration instruction sets; and
execute the first migration instruction set, wherein executing the first migration instruction set comprises selecting at least one column of the first source schema table and writing the at least one column of the first source schema table to a first target schema table.

2. The system of claim 1, wherein identifying the first migration instruction comprises locating a definition file associated with the first source schema table, and wherein the definition file comprises the first migration instruction.

3. The system of claim 1, wherein the schema identifier data associated with the first migration instruction set comprises an indication of at least one column included in the first source schema table.

4. The system of claim 1, wherein the at least one processor is further programmed to:
for a second source schema table from the list of tables, determine that the second source schema table is not associated with a migration instruction;
transfer the second source schema table to the target database.

5. The system of claim 1, wherein the at least one processor is further programmed to:
for a second source schema table, identify a second corresponding migration instruction;
execute the second corresponding migration instruction, wherein executing the second corresponding migration instruction comprises skipping the second source schema table.

6. A computer-implemented system for migrating a database from a source database having a source schema to a target database having a target schema, wherein the source schema defines a plurality of source schema tables, the system comprising:
at least one processor and operatively associated memory, wherein the at least one processor is programmed to:
identify a first source schema table associated with a first migration instruction, wherein the first migration instruction comprises a plurality of migration instruction sets, wherein each of the plurality of migration instruction sets corresponds to a version of the first source schema table;
determine that there is a match between the first source schema table and a first migration instruction set selected from the plurality of migration instruction sets;
execute the first migration instruction set, wherein executing the first migration instruction set comprises selecting at least one column of the first source schema table and writing the at least one column of the first source schema table to a first target schema table.

7. The system of claim 6, wherein identifying the first source schema table associated with the first migration instruction comprises:
receiving a list of tables at the source database, wherein the list of tables comprises the first source schema table;
traversing the list of tables, wherein traversing the list of tables comprises considering each table of the list of tables.

8. The system of claim 6, wherein identifying the first source schema table associated with the first migration instruction comprises locating a definition file associated with the first source schema table, and wherein the definition file comprises the first migration instruction.

9. The system of claim 6, wherein determining that there is a match between the first source schema table and the first migration instruction set comprise matching schema identifier data associated with the first migration instruction set to the first source schema table.

10. The system of claim 9, wherein the schema identifier data comprises an indication of at least one column included in the first source schema table.

11. The system of claim 6, wherein each of the plurality of migration instruction sets is associated with corresponding schema identifier data.

12. The system of claim 6, wherein the at least one processor is further programmed to:
identify a third source schema table without an associated migration instruction;
transfer the third source schema table to the target database.

13. The system of claim 6, wherein the at least one processor is further programmed to:
identify a second source schema table associated with a second migration instruction;
execute the second migration instruction, wherein executing the second migration instruction comprises skipping the second source schema table.

14. The system of claim 6, wherein the at least one processor is further programmed to receive a second migration instruction that is associated with a target schema table, wherein the second migration instruction comprises instructions to populate the target schema table at the target database from at least one source schema table at the source database.

15. The system of claim 14, wherein the second migration instruction comprises a plurality of instruction sets, wherein each of the plurality of instruction sets is associated with schema identifier data identifying a version of the at least one source schema table.

16. The system of claim 6, wherein the at least one column of the first source schema table comprises less than all of the columns of the first target schema table.

17. A computer-implemented method for migrating a database from a source database having a source schema to a target database having a target schema, wherein the source schema defines a plurality of source schema tables, the method comprising:
identifying, by a computing device, a first source schema table associated with a first migration instruction, wherein the first migration instruction comprises a plurality of migration instruction sets, wherein each of the plurality of migration instruction sets corresponds to a version of the first source schema table, and wherein the computing device comprises at least one processor and operatively associated memory;
determining, by the computing device, that there is a match between the first source schema table and a first migration instruction set selected from the plurality of migration instruction sets; and
executing, by the computing device, the first migration instruction set, wherein executing the first migration instruction set comprises selecting at least one column of the first source schema table and writing the at least one column of the first source schema table to a first target schema table.

18. The method of claim 17, wherein determining that there is a match between the first source schema table and the first migration instruction set comprises matching schema identifier data associated with the first migration instruction set to the first source schema table.

19. The method of claim 18, wherein the schema identifier data comprises an indication of columns included in the first source schema table.

20. The method of claim 17, further comprising:
identifying, by the computing device, a third source schema table without an associated migration instruction; and
transferring, by the computing device, the third source schema table to the target database.
